(19) United States
(12) Patent Application Publication
(10) Pub. No.: US 2009/0041915 A1
(43) Pub. Date: Feb. 12, 2009

(54) Method and device for producing expanded food

(75) Inventor: Alexander Biechteler, Ottobeuren (DE)

Correspondence Address: PERKINS COIE LLP;PATENT-SEA, P.O. BOX 1247, SEATTLE, WA, 98111-1247, US

(73) Assignee: C. Cretors & Company, Chicago, IL (US)

(21) Appl. No.: 11/661,050

(22) PCT Filed: Aug. 19, 2005
(86) PCT No.: PCT/EP2005/009010

§ 371 Date: Feb. 20, 2007

(30) Foreign Application Priority Data
Aug. 20, 2004 (DE) 10 2004 040 662.6

(51) Int. Cl. A23L 1/18; A23P 1/14

(52) U.S. Cl. 426/450; 99/323.9

(57) ABSTRACT

The invention refers to a method and a device for producing expanded food, for example popcorn, puffed rice and the like. A food is here fed to a container continuously, the food caused to expand under the effect of heat, and, after that, the food is removed continuously from the container.

### BACKGROUND OF THE INVENTION

The invention refers to a method and a device, respectively, for producing expanded food, in particular popcorn, puffed rice and the like, wherein at least one ingredient, namely the food, is fed to a container, and the food is caused to expand under the effect of heat, and, after that, the expanded food is removed from the container.

Arrangements of this type are known, for example, from the German utility model 201 20 429. Here, for example, a popcorn maker is described which is designed with a movable container which can be placed and heated, has a removable lid, and is equipped with a stirrer.

Such known arrangements are only provided for producing popcorn or other expandable food in batch quantities. The result is a considerable effort for producing popcorn, as additional staff is required. The staff must refill the ingredients in batch quantities or empty the container filled with popcorn.

### BRIEF DESCRIPTION OF THE INVENTION

Corning from this state of the art it is an object of the invention to find an arrangement through which the production of expanded food can be carried out more efficiently.

In order to solve this problem the invention suggests a method as described in the beginning wherein the ingredient is fed continuously or quasi continuously, and is moved during the effect of heat at least at times.

The suggestion according to the invention achieves a permanent, continuous production of expanded food. Quasi continuous are, however, even additions of ingredients which have an interruption as long as this does not occur in batch quantities. As a rule an operation of a corresponding arrangement in batch quantities is characterised by the fact that the container is filled in batch quantities, then the food expands, and, after that, the entire container with the expanded food, for example, is emptied. Essential in the invention is the fact that, while food already in the container expands or expanded food is conveyed out, other food, for example corn grains, can be fed.

These ingredients may be fed to the container in doses. The continuous flow rate of the single ingredients can be determined, or an amount measured in portions can be fed to the container (quasi continuously). The rate of flow can be determined through the size of the diameter of the supply line. In the supply line also a conveying means like a conveyor worm or the like may be provided by means of which the rate of flow can be determined. In particular through the selected diameter or the lead of the conveyor worm the rate of flow can be varied. The rate of flow, however, depends additionally on the rotating speed of the conveyor worm. According to a simple embodiment as conveyor means, for example, a wire spiral is provided. This wire spiral is arranged in the conveyor, in particular in the conveyor for sugar. Another advantage of a wire spiral in the conveyor is to prevent choking. If too much of an ingredient is fed at one time from the container to the conveyor this may lead to chokings. A wire spiral which moves back and forth or rotates in the conveyor channel loosens the individual ingredient particles and, through their own weight or the conveying by the worm, they are able to get in the container.

The wire spiral is caused to move by means of a drive. A separate drive for the wire spiral may be provided. However, it has turned out to be convenient to couple the wire spiral with the drive of the rakes. The drive of the wire spiral is linked, for example, with the stirring shaft of the rakes. According to an embodiment the connection is carried out via a belt or chain drive. The transmission ratio between drive shaft and wire spiral is here 1:1. However, it is desirable to choose another transmission ratio. In order to convey the ingredients sufficiently fast the wire spiral should, for example, rotate faster than the stirring shaft. For this case a gear with a transmission ratio of up to 1:5 is provided. In practice a transmission ratio of 1:3 has proved itself. As gear, for example, a toothed gearing is provided. In an exclusive embodiment it is also possible to design the transmission ratio variably by means of a gear shifting. This may be quite expensive, however, it is not excluded.

According to the invention it is sufficient if the ingredient, the food, is moved at least at times. This is achieved in a simple and functional manner by using, for example, a rake which rotates periodically the width of which is less than the level of food, and the rake moves during its combing movement through the food only a small part of the food. Alternatively it is possible to use a slower running, wider rake which in fact impresses a permanent small movement on the food (expanded and in raw condition).

The problem of the invention is solved in the same way also by a device which serves for producing expanded food like popcorn and so on which comprises a container which can be heated to which the ingredients, in particular the food, is fed continuously or quasi continuously, and the food expands under the effect of heat, and a moving device is provided which removes the food from the filling zone and conveys permanently the expanded food to an ejection opening.

The arrangement according to the invention results in a continuous production of expanded food. Here the arrangement is chosen in such a way that it works completely automatically, and thus the required staff is very small. The arrangement of a moving device which takes care that the food is removed from the filling zone makes sure that the food is distributed as evenly as possible in the container for expanding, and the expanded good which often is 24 to 30 times larger than the non-expanded food is conveyed then in the direction of the ejection opening. The conveying quality of the moving device thus is not restricted to non-expanded or expanded food, but is able, of course, even to convey both simultaneously.

In a preferred modification of the invention it is provided that the expanded food is separated from the non-expanded food. Such a separation, for example, takes place automatically by the fact that the expansion is carried out in an explosion, and the released energy is also a result of the kinetic energy of the food, for example the individual grain. Also, as a rule, the density of the expanded food decreases considerably compared with the non-expanded food, and that also results in a corresponding separation. This separation is convenient as the heavy, not yet expanded food will rest automatically on the bottom, and the conveying movements in the upper region removes the already expanded food.

According to the invention a moving device is provided which, first of all, distributes the (non-expanded) food. However, this also serves for removing the expanded food from the container following the movement of the ingredient during the effect of heat. The expanded food, for example, is conveyed to an ejection opening at the container through which the expanded food can leave the container. It is essential that this removal movement of the expanded food is carried out during, that means at the same time as, the expansion of other food as a consequence of the effect of heat or the refilling of food in the container. Thus the arrangement is chosen in such a way that in the ideal case the first layer of the expanded food is removed immediately from the container in order to create a free volume for the further expansion of food. Cleverly the expansion of food and the removal of the already expanded food is here done simultaneously.

It has proofed to be convenient if between the container bottom and the ejection opening an edge is provided. Thus only the popped food which is resting above the non-popped food because of its lower specific weight by the movement is conveyed out through the ejection opening. The heavier, non-popped food is held back by the edge.

It is now desirable, depending on the amount of food which has to be processed simultaneously, to vary the level of the edge. For that purpose at the bottom border of the ejection opening a verge is provided. This verge may be arranged, for example, at the edge of the container. According to an embodiment this verge is linked fixedly with the edge and thus increases the distance between container bottom and ejection opening.

According to another embodiment the verge may be fastened to the edge in such a way that it can be exchanged. Depending on the requirements then either a wide or a narrow verge is attached in order to reach the desired level of the ejection opening relatively to the container bottom.

According to a third modification the verge is fastened to the edge in such a way that it can slide for height adjustment. According to a simple modification the edge consists of a metal sheet strip which is guided in brackets punched and bent out of the edge.

However, the verge may also be arranged in a container wall placed upon the edge. According to this embodiment in the container wall the ejection opening is integrated. The verge is attached to the container wall in the region of the ejection opening fixedly and slideable for height adjustment like in the previous embodiment.

According to a preferred modification the container wall limits the ejection opening only laterally. A verge arranged at the bottom edge also covers the region of the ejection opening. An identical verge of this type may also be provided at the top edge of the container wall. It is convenient if both verges are designed with a different width.

In this way the arrangement of the ejection opening may vary even further depending on the way the container wall is placed upon the edge of the container. According to this embodiment a verge from sheet metal is chosen. In the same way the verge may be made from another material, for example synthetic material. It has proved advantageous to design the verge of the sheet metal sharp-edged. Unfinished grains which may adhere to the popped food thus are wiped off at the verge and fall back in the container.

The method according to the invention is characterised by the fact that, while the expanded food is removed, new ingredients are fed.

According to the invention as ingredients count in any case the food to be expanded, for example corn grains, rice and so on. However, also other materials count as ingredients, which support, for example, the expansion or give a certain flavour to the food. Thus it is provided that other ingredients, for example oil or fat or flavours like sugar, salt, syrup and the like are added.

However, the term “ingredients” has to be understood according to the invention that it may also be used as substance term. That means the word “ingredients” does not necessarily mean different ingredients but for example the food as individual substance. In this respect the method according to the invention, where advantageously new ingredients are fed while expanded food is removed, is not restricted to the fact that simultaneously new ingredients, these are for example oil and sugar, are fed but only new food to be expanded is fed as ingredient.

In view of the preparation of the different ingredients the invention is very flexible. First of all, it is, for example, suggested that all ingredients or only a part of the ingredients, in particular excluding the food, are mixed and, after that, fed to the container. For example the different ingredients, that means food, oil and flavours each are stored individually. In a first modification of the invention it is, for example, provided, that these single ingredients each are fed individually to the container and are mixed only there. In another modification it is provided that, for example, the food is fed individually to the container, the other ingredients, that means oil and flavours, are mixed, that means stirred, and are fed to the container with the food after that. The different combination has advantages for mixing the ingredients and their transport, respectively, to the container as thus a homogenous mixing ratio of the different ingredients which remains the same during the process can be guaranteed. Interruptions of the operation, for example by oil adhering to the food, may be prevented by that. The arrangement according to the invention thus increases considerably the operational security.

A continuous or quasi continuous process can be carried out although the ingredients are fed to the container individually, one after the other or simultaneously, and are mixed there or at another place. For example, it is possible to chose the process control in such away that in the container the ingredients get to a first region, and are mixed there, and only then the actual expansion is then carried out at another place of the container.

It has been found to be convenient to provide the ingredients with heat while they are moved for mixing. It is in particular a possibility here to warm the ingredients suitably before they are actually in the container. The same is, of course, also possible when the ingredients are fed to the container, and are warmed there suitably during the mixing movement.

In a clever arrangement of the invention it is provided that the movement for mixing the ingredients also serves for separating the expanded food from the non-expanded food. Mixing of the ingredients and separating the expanded from the non-expanded food actually takes place at the same time. For example, for mixing a suitable stirring apparatus is provided which, for example, simultaneously or at another place within the container, serves for separating the expanded food from the non-expanded food, and, if necessary, additionally for conveying the expanded food to the ejection opening.

The arrangement of the invention is chosen in such a way that a continuous removal of the expanded food results. In particular such a result is received even if the raw material, that means the ingredients, are not fed continuously. The processing procedure, expansion of the food, is not carried out in the same speed for the ingredients. Thus an interrupted feeding of the ingredients does not lead to an interruption of the ejection of expanded food.

In the device according to the invention for producing expanded food in particular a moving device is provided which conveys the food away from the filling zone. Conveniently it is provided that the moving device has a rake. For the design of the rake very different modifications can be used, and are also advantageous according to the invention.

Therefore, for example, in a modification of the invention it is provided that the rake is sickle shaped. Through the sickle form it is possible to vary the circumferential speed of the grain or expanded food moving on the rake accordingly. Through the form of the rake eventually the way of the food to be expanded through the container can be set when it is fed in the central region and lead to the outside. Besides a sickle shaped design it is also possible that the rake is essentially straight or rod-like, or consists of bent, rod-like parts. The term rake is not used here because it has prongs but is an article which brushes uniformly the surface. As it is here a uniform brushing as homogeneously as possible of the hot container bottom it is convenient to design the rake rod-like or wing-like, in particular without prongs.

In order to prevent grains of the food from remaining adhering undesiredly at the rake the cross section of the rake is preferably circular or smoothed off, for example oval.

The application claims method as well as device aspects. The arrangement of the individual features is not restricted to the chosen statutory class of claims, device characteristics may also be claimed and interpreted in the method claims, and vice versa, without describing expressly this modification.

### DESCRIPTION OF THE DRAWINGS

Preferred embodiments of the invention are described in other sub-claims and are shown schematically in the drawing. In the drawing:

FIGS. 1 and 2 each in a side view a schematic view of the invention;

FIGS. 3 and 4 each in a three-dimensional view the device according to the invention;

FIGS. 5 and 6 details in a three-dimensional view of the device according to the invention, and

FIG. 7 a partial view of the container, in a section, according to the invention.

### DETAILED DESCRIPTION OF THE INVENTION

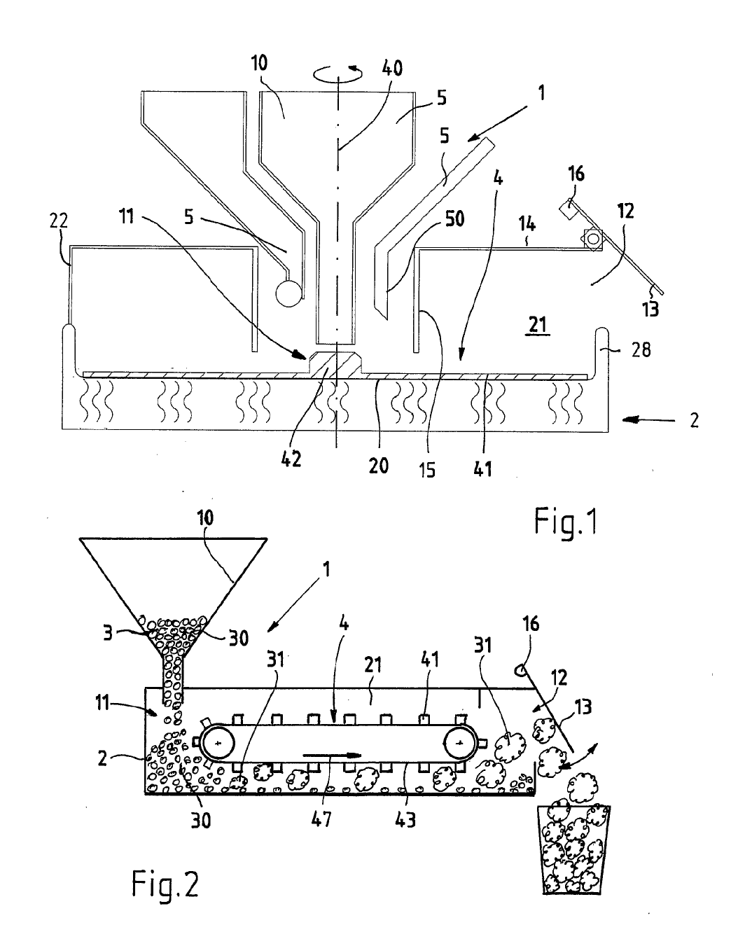

In FIG. 1 the invention is shown schematically. Device 1 is formed in the embodiment shown here first of all by a container 2, and its container bottom 20 can be heated. Above the container 2 the conveyors 5 for the ingredients 3 are provided. In the example shown here three ingredients altogether are fed each via one of three conveyors 5. For example, the conveyor 5 arranged in the middle is provided for the food, the right-hand conveyor 5 serves as oil conveyor 50, the left-hand conveyor 5 serves as conveyor for flavours like sugar or salt and so on.

As food material which can be poured or grains, for example corn, rice or the like is provided. At least the food is lead through the centrally arranged conveyor 5 from above to the container.

The device has a moving device 4. This is here designed for example as a stirring apparatus which is equipped with a rake 41 and can rotate around the vertical axis 40. The moving device 4 takes care that continuously supplied ingredients 3 are distributed fast and homogeneously on the hot container bottom 20. At the same time the moving device 4 serves also for mixing homogeneously the individual ingredients 3 which are fed by the conveyors 5. This is achieved by a suitable design of the rakes 41 of the moving device 4. The food 30 thus placed upon the hot container bottom 20 is warmed until it expands. Thus, for example, popped corn is made from a corn grain. The rake 41 is designed resting on the container bottom or arranged with a little space above the container bottom. This makes sure that the grains of the food layer resting downstairs on the container bottom 20 are moved regularly and transported. Because of the rotational movement of the rake the grains of the food here move radially to the outside so that the filling zone 11 inside extending below the conveyors 5 is emptied. Thus permanently the opportunity is created that other grains of the food 30 can be supplied so that a continuous expanding of the food is possible.

Of course, the arrangement is chosen in such a way that the feeding of other food grains to the container is not obstructed, that means that there are no chokings or the like. For that purpose for example the central conveyor 5 is arranged not exactly concentrically but a bit displaced. Or the hub 42 of the rake 41 has a smaller diameter than the open width of the central conveyor 5.

Cleverly the height of the rake is only about half the diameter of the single element of the ingredient, for example the corn grain. By means of this design it is achieved that the single element, that means the food grain, in the present example the corn grain, is also lifted from the container bottom by the rotating rake, and is lifted over the rake above. As this is carried out permanently and continuously the risk of an incrustation of any ingredients on the bottom of the container is reduced strongly. In this connection it is convenient that the rake 41 is arranged and moves either resting on the container bottom or with a small distance over the bottom.

By means of the moving device, in particular here the rake 41, the ingredient is caused to move radially to the outside on the hot container bottom, and also a suitable mixing of the different ingredients with for example fat and oil or flavours is achieved.

The rotating speed of the rake or the speed of the moving device 4, the distance between ejection opening 12 and filling zone 11, and the heat of the container bottom 20 are matched to each other in such a way that, while the corn is transported radially to the outside, it can expand, and, after expanding, the expanded food will leave the device via the ejection opening 12. The suitable tuning may be found easily empirically.

In experiments it has turned out to be convenient to provide an annular cover 14 which is connected at its exterior edge with the container wall 22, however, on the inside or the inner edge of the annular cover 14 has a border wall 15. This border wall 15 does not rest on the container bottom 20, but it forms a certain gap with it which is dimensioned such that in any case the non-expanded food and, if necessary also a certain small part of the expanded food still slips through. This annular cover 14 serves for storing the expanded good 31, before it gets to the ejection opening 12 provided only at one side and is conveyed out.

In the examples shown here in FIG. 1 and FIG. 2 the ejection opening 12 is closed by a closing flap. The ejection opening 12 is designed for that on the side of the container 2 as opening. The joint is here above the ejection opening 12. To the flap 13 on the other side of the joint also a counter weight 16 is connected. The arrangement is now made in such a way that the closing flap 13 is in contact with the container 12, that means it closes the ejection opening 12. If now in the interior 21 of the container such a large supply of expanded food is collected the flap 13 is pressed to the outside so that it opens. This is caused by the permanent production and supplying of expanded food. However, if now the closing flap 13 is swung a bit the counter weight 16 aids to form an antitorque moment to the weight of the flap 13. The opening movement of the closing flap 13 is thus made easier. Conveniently at the ejection opening 12 a slide is provided through which the expanded food can be removed in a desired way.

The ejection opening 12 is, in a preferred modification, not drawn down entirely to the container bottom 20. It is advantageous if an edge 28 remains between the container bottom 20 and the ejection opening 12. Thus it is avoided that not yet expanded food, that means grains, leaves the interior 21 of the container unintentionally.

In FIG. 2 another device according to the invention is shown. In contrast to the rotational movement of rake 41 according to FIG. 1 here a linear movement of rake 41 is provided. In the interior 21 of the container a conveyor belt is provided which has a revolving belt 44 on which the rakes 41 are arranged. Here a number of rakes 41 is provided. Through the movement of the belt now the rakes 41 are moved essentially horizontally and linearly, respectively.

In the left-hand region a supply container 10 for the food 30 as ingredient 3 is provided. The food 30 is filled in the non-expanded condition in the filling zone 11 in the container 2 on the left. The direction of movement 4 now takes care that the food 30 is transported to the right. Again the container bottom 20 has a heating which causes the food to expand. This is indicated, for example, by reference number 31. This expansion, the popping, takes place, for example, below the belt. At the same time the expanded food 31 is transported further to the right; in the right-hand region there is again an ejection opening 12 which can be closed by a flap 13 with counter weight 16. This arrangement here is similar to the one in FIG. 1. The example shows that the direction of movement 4 has several rakes 41 as also the modification according to FIG. 1. As the rakes 41 eventually are responsible for a movement of the food, in particular away from the filling zone and to the ejection opening 12 a large number of rakes is really convenient.

However, it is therefore also convenient, as shown in FIG. 1, that the moving device 4 consists of at least one rake 41 rotating around a vertical axis 40. In the example shown here in FIG. 1 at least two rakes can be discerned, however, an even larger number can be used; in the example according to FIG. 6, for example, eight rakes 41 are used.

In the embodiment shown in FIG. 2 the distance of the belt 44 on the bottom surface of the container bottom 20 along the belt is always the same. However, as now through an expansion also a considerable increasing of the volume of the food takes place, between 24 and 30 times, this fact may be compensated by widening the region below the belt 44, along the belt 44 in the conveying direction 47 of the food 30, 31. For that there are three modifications.

In the first modification the conveyor belt 24 is tilted a bit, in the second modification the container bottom 20 is slightly inclined and in the third modification a slightly tipped conveyor belt 43 is combined with a slightly inclined container bottom 20.

The same is also possible in rotational symmetric modifications. A funnel-like design, for example, of the cover above the container bottom from the inside to the outside supports also a transport of the expanded food to the outside to the ejection opening.

In a preferred modification of the invention it is provided that the bottom 20 of the container 2 can be heated. This is convenient as the food to be expanded primarily rests on the container bottom. However, it is also advisable to warm the side walls of the container, if necessary, so that the heating time of the food is reduced.

According to the invention it is provided that the container bottom has a heating, or in the container 2 a separate hot plate is arranged. The separate design has the advantage that this hot plate can be exchanged separately in the case of maintenance. Integrating the heating in the container bottom has the advantage that the complete arrangement is less high and can be realised more elegantly.

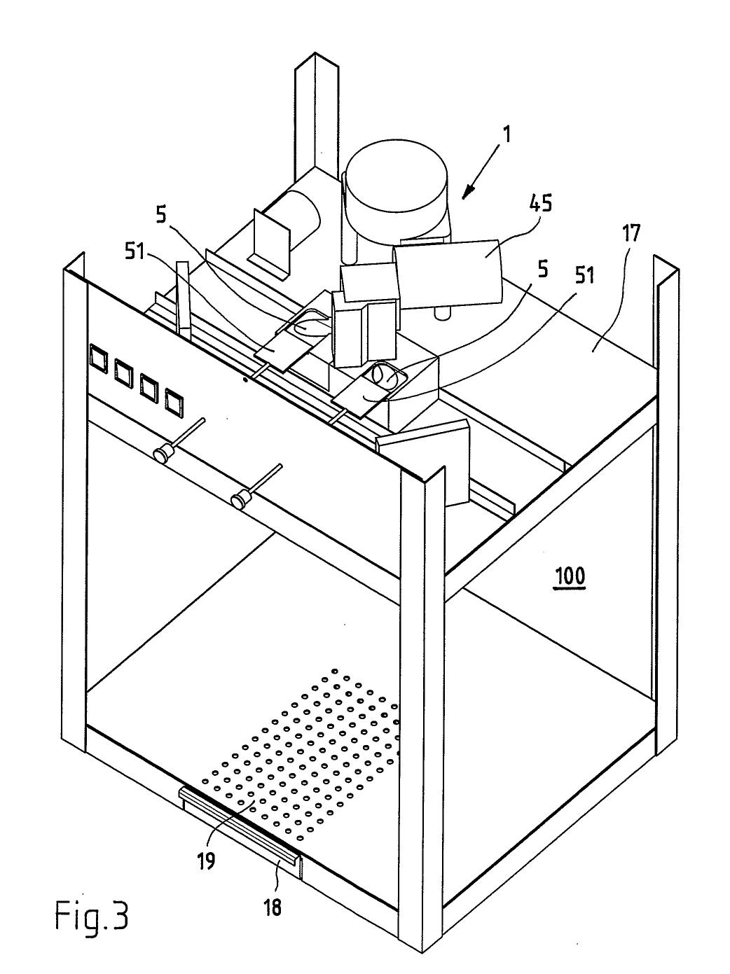

In FIG. 3 a three-dimensional view of the device according to the invention is shown. The view seen here from above makes it possible to look from above into the device 1 according to the invention. The condition shown here shows the device according to the invention with supply containers 10 removed. However, also the two conveyors 5 are shown, one serving for example as corn or sugar conveyor 50. The oil is fed to the container separately, for example, through a pump or a centrifuge. By means of the pump the amount of oil can be dosed considerably better. Small amounts of oil may be fed continuously to the container, or, according to the supplied amount of food, the entirely required amount of oil. In order to control or interrupt the flow of ingredients sliders 51 are provided through which the connection of conveyor 5 to the respective supply containers 10 can be controlled and interrupted. A motor 45 is provided for the moving device 4. In this example it serves for driving the shaft carrying the rake. This region is covered by the top cover 17. Of course also in the case that a conveyor belt is provided for moving the rake 41, also a motor is provided.

Cleverly the cover 17 also serves at the same time as cover of the container 2. By means of that the region where the food is expanded is separated from the region for machine parts for the drive of the moving device, the control for the supply of the ingredients and the supply container. At the same time this region is also safe from fat splashes which cannot be avoided in the production of such expanded food.

The embodiment of the invention shown in FIG. 3 is chosen in such a way that below the device a supply for the expanded food ejected through the ejection opening 12 is provided from which the popcorn is taken when needed.

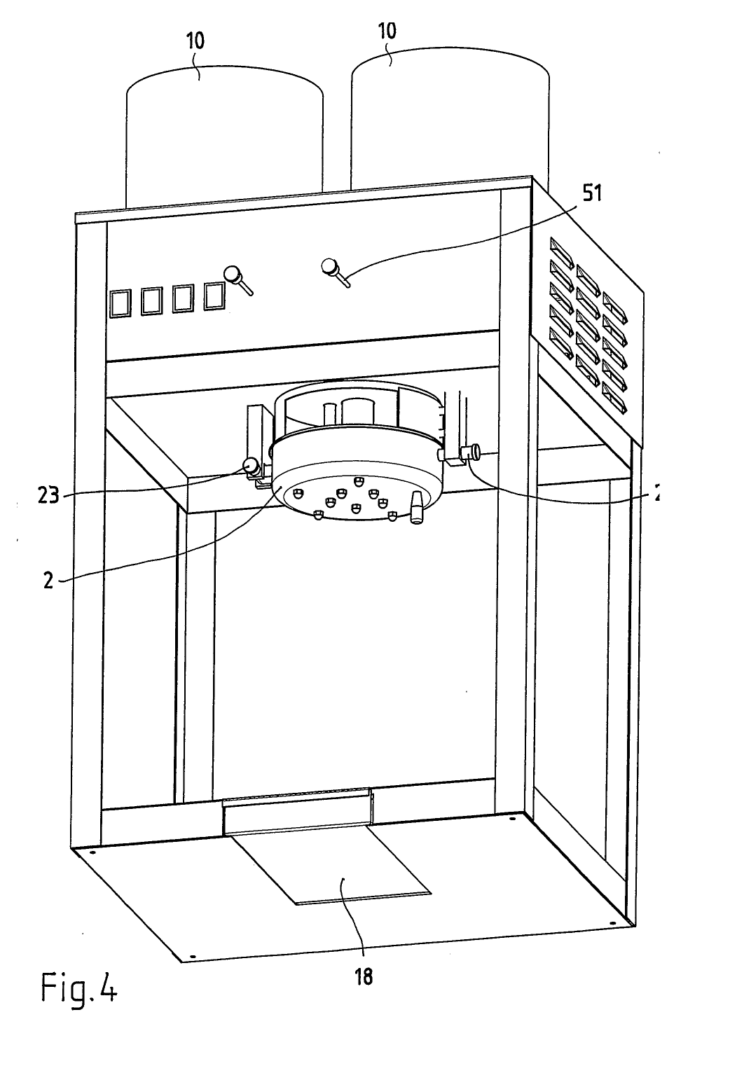

Reference number 18 shows a grain drawer in FIG. 3 and FIG. 4. Above the grain drawer 18 in the bottom of the supply there is a sieve 19. If nevertheless non-expanded grains get in the supply they will be collected through the sieve 19 in the grain drawer 18.

FIG. 4 shows an angle of view from above to the top in the supply 100. The bottom region of the container 2 can be seen, the top region is covered by the screen of the device 1, through the screen the sliders 51 extend. In the embodiment shown here the two supply containers 10 are placed upon the conveyors 5.

Device 1 consists of a cube-like or box-like basic frame which holds the supply 100 as well as in the top region the container 20 with the heating of the moving device 4 and so on. The container is supported flexibly on one side so that it can be cleaned easily. The joint is indicated with 23.

On the side of the container 2 opposite the joint 23 a stop bolt 24 is provided. By means of this the container can be fixed.

The arrangement is expressly clean as the tilted container 2 is emptied with the container wall 22 in the supply 100, and thus soil does not get to the outside.

FIG. 6 shows in a detail the moving device 4 combined with the container 2.

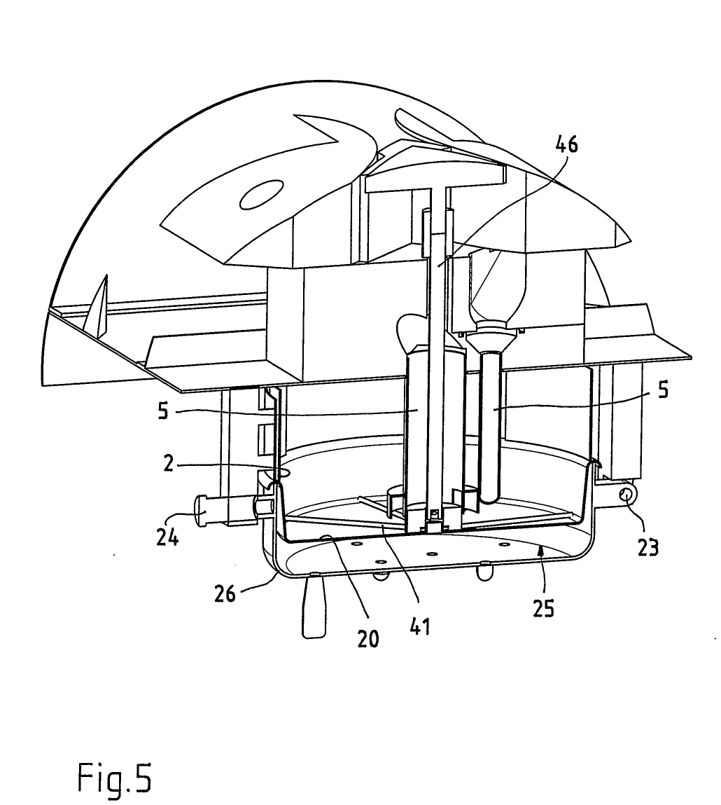

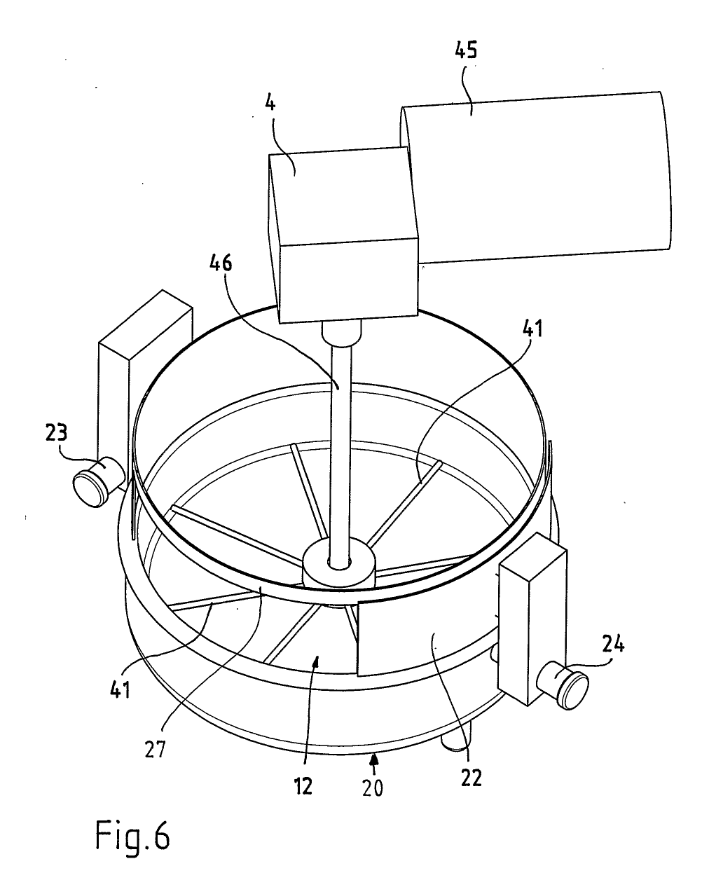

In FIG. 5 the combined structural component shown in FIG. 6 is built in. Additionally the conveyors 5 can be seen.

Below the container bottom 20 there is, bordered by another cover 26, a space 25 where the hot plate or the heating can be assembled.

In the example shown in FIG. 5 it can be seen easily that in the central conveyor which feeds the food 30 the drive shaft 46 or the vertical axis 40 of the moving device 4 is arranged. By means of such a construction preferably concentrically an optimal equal distribution of the food in the container 2 is achieved. Through the slider 51 (not shown in FIG. 5) the rate of flow of the ingredients through the respective conveyors can be set. The different size of the ingredients is compensated by different diameters of the conveyors for food, flavour and oil. It is decisive that the ingredients are fed continuously in the correct recipe.

In FIG. 6 the container 2 with the placed-upon container wall 22 is shown. The container wall 22 is limited at its upper edge by a verge, in particular by a sheet metal verge 27. This sheet metal verge 27 extends across the ejection opening 12. The container wall 22 can be removed from the container bottom 20. According to a modification of the invention the container wall 22 can be placed upside down upon the container bottom. The circumferential sheet metal verge 27 than rests directly on the edge of the container 2. The position of the ejection opening 12 is then higher, compared with the container bottom 20, than it is provided in the presented embodiment. The container wall 22 may also be bordered on the top and bottom by a sheet metal verge 27. Advantageously these are designed in different heights so that the position of the ejection opening 12 may be selected even more flexibly.

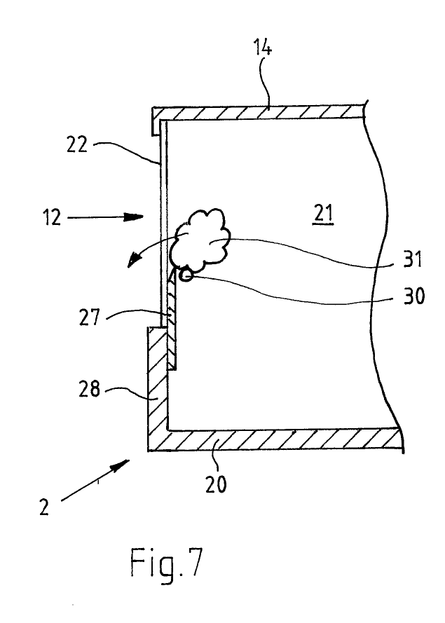

In FIG. 7 the device 1 for producing expanded food 31 is shown in a sectional view. A container wall 22 is placed upon the container bottom 20 with an edge 28 formed at it. The device 1 is covered on the top surface by the cover 14. In this example the verge 27 is attached to the container wall 22 in such a way that, when the container wall 22 is placed upon, a part of the verge 27 projects in the container 2. The verge 27 is designed at its top side sharp-edged. If expanded food 31 to which non-expanded food 30 still adheres is conveyed out of the container 2, the non-expanded food 30 is wiped from the expanded food 31 by the verge 27 and falls back in the container 2.

In a preferred modification of the invention it is provided that in a first conveyor the food to be expanded gets in the container, and in a second conveyor, for example, oil and sugar are mixed with each other and are added in this way to the food. This is the smaller conveyor 5, arranged in FIG. 5 on the right side of the drive shaft 46.

For an optimal mixing ratio it is provided that the individual ingredients are fed to the container, which is designed in this case rotational symmetric, as centrally as possible.

Conveniently a pump is provided by means of which the oil is added to the food and/or the container. According to this modification it is possible that the oil either gets directly in the container, or is pre-mixed in connection with the food, or is mixed with the flavour (this modification is also part of the invention).

The claims filed with the application now and to be filed later on are attempted formulations without the prejudice for obtaining a broader protection.

If here, on closer examination, in particular also of the prior art, it turns out that one or the other feature may be convenient for the object of the invention, however, not decisively important, of course, already now a formulation is striven for which does not contain anymore such a feature, in particular in the main claim.

References in the sub-claims relate to the further design of the main claim through the characteristics of the respective sub-claim. These are, however, not to be understood as a waiver of independent protection of the matter for the characteristics of the referred sub-claims.

Characteristics only disclosed now in the description so far may in the course of proceedings, be claimed as being of inventive relevance, for example, to distinguish from the prior art.

Characteristics only disclosed in the description or even single characteristics from claims which comprise a variety of characteristics may be used at any time to distinguish from the state of the art in the first claim, and this is even if such characteristics have been mentioned in connection with other characteristics or achieve particularly convenient results in connection with other characteristics, respectively.

1. Method for producing expanded food, in particular popcorn, puffed rice and the like, wherein at least one ingredient, namely the food, is fed to a container, and the food is caused to expand under the effect of heat, and, after that, the expanded food is removed from the container, wherein, first of all, the ingredient is fed continuously or quasi continuously, and is moved during the effect of heat at least at times, characterised in that the ingredient is put in the container on a heatable bottom, and the ingredient is conveyed from a filling zone inside through a rotating stirring apparatus radially to the outside, and there a separation of expanded from non-expanded food takes place.

2. Method according to claim 1, characterised in that the expanded food is separated from the non-expanded food because of the different specific weights.

3. Method according to claim 1, characterised in that the expanded food is conveyed out of the container following the movement of the ingredient during the effect of heat.

4. Method according to claim 1, characterised in that, while the expanded food is conveyed out, new ingredients are fed.

5. Method according to claim 1, characterised by the addition of other ingredients like oil, fat and/or flavours like salt, sugar, syrup and the like.

6. Method according to claim 5, characterised in that all ingredients or only a part of the ingredients, in particular excluding the food, first of all, are mixed and, after that, fed to the container.

7. Method according to claim 5, characterised in that the ingredients are fed to the container individually, one after the other or simultaneously, and are mixed there with each other.

8. Method according to claim 5, characterised in that the ingredients are added in doses.

9. Method according to claim 5, characterised in that the ingredients are provided with heat during the movement for mixing.

10. Method according to claim 4, characterised in that the movement for mixing the ingredients is also provided for separating the expanded food from the non-expanded food.

11. Method according to claim 1, characterised in that by means of the movement the expanded food is conveyed to an ejection opening.

12. Method according to claim 1, characterised by the continuous removal or supply of the expanded food.

13. Device for producing expanded food, in particular popcorn, puffed rice and the like, comprising a container (2) which can be heated, to which the ingredients (3), in particular the food (30), are fed continuously or quasi continuously, and the food (30) expands through the effect of heat, and a moving device (4) is provided which conveys the food (30) away from the feeding zone (11), and conveys the expanded food (31) permanently to an ejection opening (12), characterised in that the moving device (4) comprises at least one rake (41) rotating around a vertical axis.

14. Device according to claim 13, characterised in that the rakes (41) are driven by a shaft (46).

15. Device according to claims 13 and 14, characterised by an at least in sections horizontal movement of the rake (41).

16. Device according to claim 14, characterised by a linear or rotating movement of the rake (41).

17. Device according to claim 13, characterised in that the moving device (4) has several rakes (41).

18. Device according to claim 13, characterised in that the rake (41) is sickle shaped.

19. Device according to claim 13, characterised in that the cross section of the rake (41) is circular.

20. Device according to claim 13, characterised in that the rake (41) consists of a straight or a bent, rod-shaped part.

21. Device according to claim 13, characterised in that the height of the rake (41) is about half the diameter of the single element of the ingredient (3), for example the corn grain.

22. Device according to one claim 13, characterised in that the rake (41) is arranged either resting on the container bottom (20) or with a small space above the container bottom (20).

23. Device according to claim 13, characterised in that on the side of the container (2) an opening is provided as ejection opening (12) for the expanded food (31).

24. Device according to claim 23, characterised in that the moving device conveys the expanded food (31) to the ejection opening (12).

25. Device according to claim 23, characterised in that following expanded food (31) conveys the food (31) at the ejection opening (12) out of the container (2) through the ejection opening (12).

26. Device according to claim 23, characterised in that a slide is provided at the ejection opening (12).

27. Device according to claim 23, characterised in that the ejection opening (12) is provided with closing flap (13).

28. Device according to claim 27, characterised in that the closing flap (13) is supported swinging at the container (2).

29. Device according to claim 28, characterised in that a counter weight (16) is provided at the closing flap (13).

30. Device according to claim 13, characterised in that between the container bottom (20) and the ejection opening (12) an edge (28) is provided.

31. Device according to claim 13, characterised in that at least the bottom border of the ejection opening (12) is provided with a verge (27).

32. Device according to claim 31, characterised in that the verge (27) is sharp-edged.

33. Device according to claim 13, characterised in that the distance of the ejection opening (12) to the container bottom (20) may vary.

34. Device according to claim 31, characterised in that the height of the verge (27) may vary relatively to the edge (28) of the container (2).

35. Device according to claim 31, characterised in that the verge (27) is arranged at a container wall (22) which can be placed upon the edge (28) of the container (2).

36. Device according to claim 35, characterised in that the container wall (22) limits the ejection opening (12) at least laterally.

37. Device according to claim 31, characterised in that the verge (27) is arranged at the top and/or bottom border of the container wall (22), and extends over the region of the ejection opening (12).

38. Device according to claim 31, characterised in that one of the edges (27) is wider than the other edge.

39. Device according to claim 20, characterised in that the position of the ejection opening (12) can be selected by different placing of the container wall (22) upon the edge (28) of the container bottom (20).

40. Device according to claim 13, characterised in that the ingredients (3) are fed to the container (2) via a conveyor (5).

41. Device according to claim 40, characterised in that in the conveyor (5) of the food (30) the drive shaft (46) or the vertical axis of the moving device (4) is arranged.

42. Device according to claim 13, characterised in that the ingredients (3) are fed to the container (2) in doses.

43. Device according to claim 40, characterised in that the rate of flow of the ingredients (3) can be adjusted through the conveyor (5).

44. Device according to claim 40, characterised in that in particular for the addition of sugar a conveyor means, in particular a wire spiral is provided which is arranged in the conveyor (5).

45. Device according to claim 40, characterised in that the conveyor means, in particular the wire spiral, is linked with the drive shaft (46) of the rakes (41) via a gear.

46. Device according to claim 40, characterised in that the transmission ratio of drive shaft (46) to conveyor means is between 1:1 to 1:5, in particular 1:3.

47. Device according to claim 40, characterised in that at the conveyor (5) a slider (51) is provided for interrupting the supply.

48. Device according to claim 40, characterised in that the diameters of the conveyor (5) for food (30), flavour and oil have different sizes.

49. Device according to claim 13, characterised in that the individual ingredients (3) are fed to the container (2) as centrally as possible.

50. Device according to claim 13, characterised in that a pump is provided by means of which oil is fed to the food (30) and/or the container (2).

51. Device according to claim 13, characterised in that in the container (2) a hot plate is provided.

52. Device according to claim 13, characterised in that at least the container bottom (20) of the container (2) can be heated.

53. Device according to claim 13, characterised by a motor (45) driving the moving device (4).

54. Device according to claim 13, characterised in that the container (2) is provided with a cover (14).

55. Device according to claim 13, characterised in that the container (2) is arranged in or above a supply (100) into which the expanded food (31) ejected through the ejection opening (12) gets.

56. Device according to claim 55, characterised in that at least the container (2) is provided in the device (1) in such a way that it can swing and be fixed.

57. Device according to claim 13, characterised in that a conveyor belt (43) is provided for the movement of the rakes (41).
